(19) United States
(12) Patent Application Publication
(10) Pub. No.: US 2019/0084602 A1
(43) Pub. Date: Mar. 21, 2019

(54) UTILITY CART

(71) Applicant: Geerpres, Inc., Muskegon, MI (US)

(72) Inventors: Scott E. Ribbe, West Olive, MI (US); Carleton Wright, Twin Lake, MI (US); Dale Bucy, Muskegon, MI (US)

(73) Assignee: Geerpres, Inc., Muskegon, MI (US)

(21) Appl. No.: 15/711,389

(22) Filed: Sep. 21, 2017

(51) Int. Cl. B62B 3/10; B62B 3/04; B62B 5/06; B62B 3/00

(52) U.S. Cl. CPC B62B 3/10; B62B 3/04; B62B 3/005; B62B 3/004; B62B 5/067

(57) ABSTRACT

A large platform utility cart having a frame enclosed elongated wheeled platform, tool holders and a cabinet mounted on the platform, and a fold down ramp on each side of the platform for wheeling wheeled appliances up onto the platform.

### FIELD AND BACKGROUND OF THE INVENTION

The present invention relates to utility carts. Such carts typically include a wheeled platform with an upstanding handle at one or both ends. Utility carts are moved manually by pushing or pulling on the handle(s). Such carts may include one or more shelves spaced above the platform, mounted between the handles. An enclosed bin may be mounted on the platform, for holding products, parts, or the like. Often, utility carts include a cabinet mounted on the platform, and sometimes the platform extends far enough beyond the cabinet to carry a cleaning bucket or the like.

While larger carts are sometimes found in factory settings, the utility carts designed for hospitals, medical centers, offices and the like are about two feet by three feet in dimensions. As such, these carts do not carry all the tools, supplies and equipment necessary to do a large cleaning job, as for example the entire floor of a hospital. It may take several carts or several trips from the supply room up the elevator to the floor to be cleaned to get all the necessary supplies and implements in position to do the job. Even with that, heavy floor cleaners usually must be wheeled to the cleaning location separately from the utility cart(s).

### SUMMARY OF THE INVENTION

The utility cart of the present invention comprises an elongated wheeled platform, at least one tool holder mounted on said platform, and at least one fold down ramp for wheeling wheeled appliances up onto the platform. These and other features, objects and advantages of the present invention will be further understood by reference to the drawings and the Description of the Preferred Embodiments.

### BRIEF DESCRIPTION OF THE DRAWINGS

FIG. 1 is a 45° perspective view of a preferred embodiment utility cart of the invention;

FIG. 2 is a side perspective view of the cart;

FIG. 3 is a 45° perspective view of the preferred embodiment cart loaded with appliances and tools;

FIG. 4 is a generally end perspective view showing a floor cleaner being rolled up the fold down ramp onto the preferred embodiment cart;

FIG. 5A is a perspective view of the lock mechanism for holding the fold down ramp in its locked-up position, with the lock in its unlocked position;

FIG. 5B is the same view as FIG. 5A, but with the lock in its locked position; and

FIG. 6 is a fragmentary view of one of the tool holders of the cart showing the tool retainers holding several implements.

### DESCRIPTION OF THE PREFERRED EMBODIMENTS

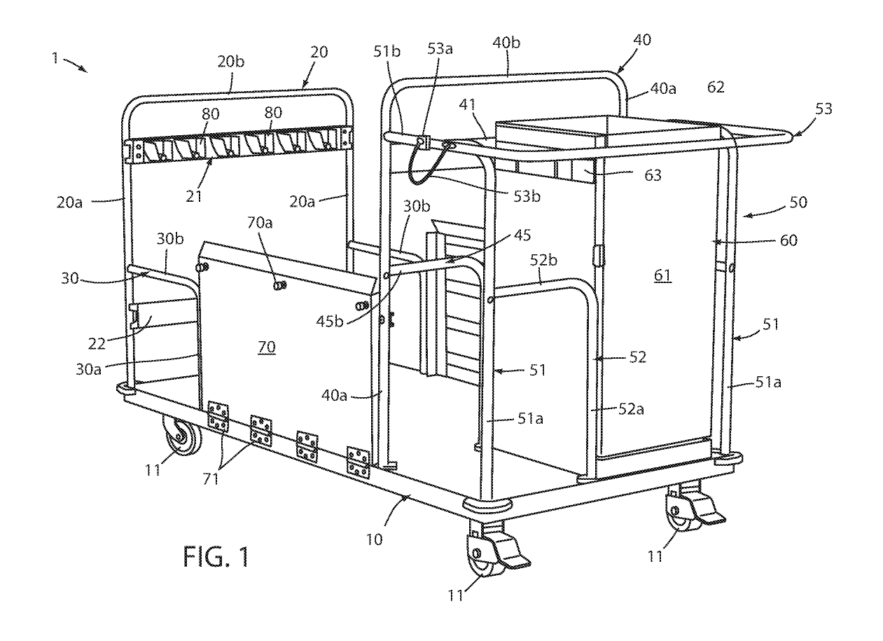

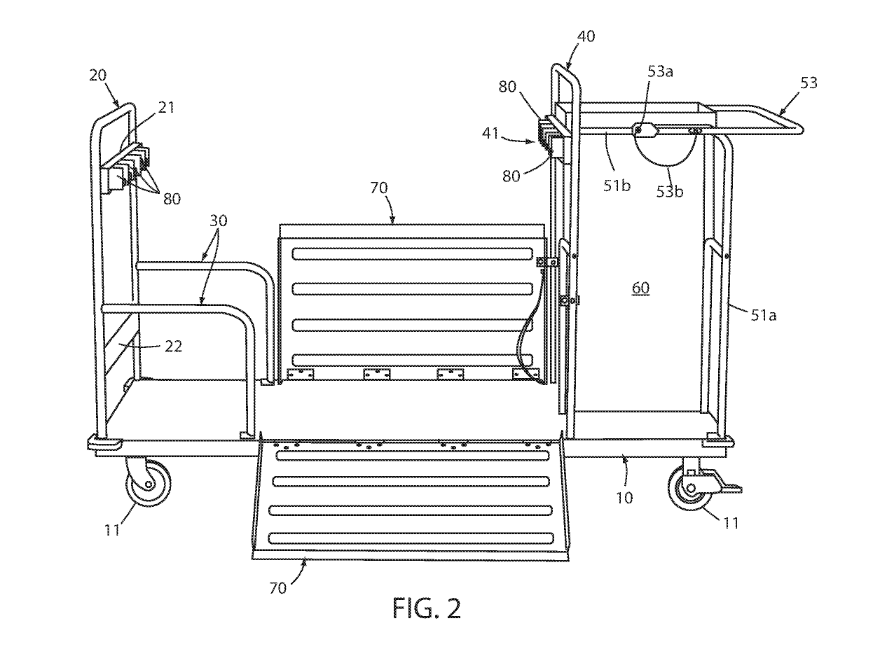

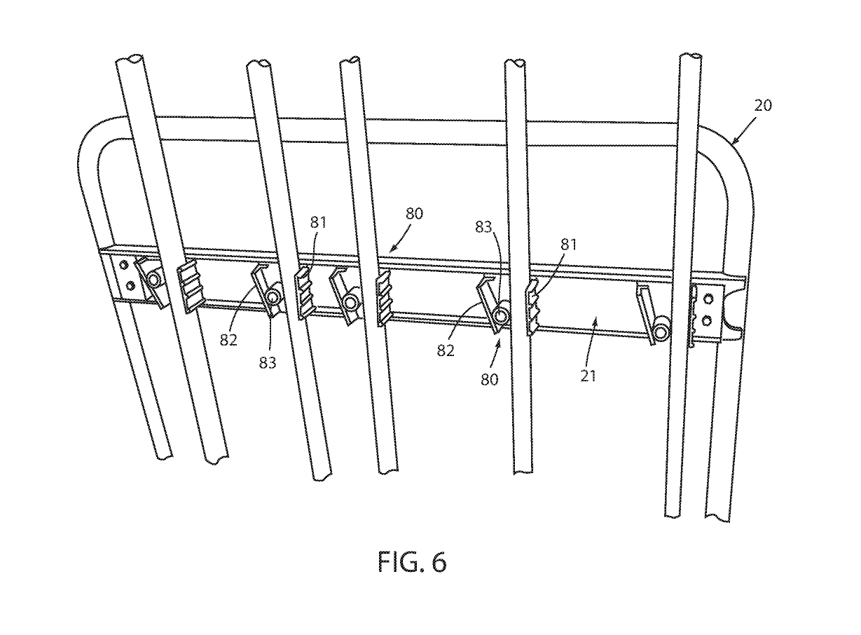

The cart 1 of the preferred embodiment comprises a wheeled platform 10, an end frame 20, side frames 30, mid-frame 40, end frame assembly 50, cabinet 60, fold down ramps 70 and tool holders 80 (FIGS. 1-3). The various frame members help keep items loaded onto the cart in place. The fold down ramps do the same in their up positions, but when folded down allow users to load larger wheeled appliances such as floor cleaners onto cart 1. Cabinet 60 provides enclosed lockable storage for numerous items, including cleaning chemicals and the like which must be securely retained for safety purposes. The tool holders 80 (FIG. 6) allow the user to locate tools on the various tool holder bands 21, 41 and 63. The various component members are listed and numbered in the parts list below:

### PARTS LIST

Cart 1
Platform 10
Casters 11
End frame 20
Croner posts 20a
Cross bar 20b
Tool holder band 21
End retaining band 22
Side frame members 30
Vertical post 30a
Cross bar 30b
Mid-frame 40
Vertical posts 40a
Cross bar 40b
Tool holder band 41
Lower mid frame 45
Post 45a
Cross bar 45b
End frame assembly 50
Corner frame members 51
Corner post 51a
Rearwardly extending top bar 51b
End lower frame 52
Center post 52a
Cross bar 52b
Pivoting handle 53
Pivot mount 53a
Chain 53b
Cabinet 60
Door 61
Top tray 62
Tool holder band 63
Fold Down Ramps 70
Hinges 71
Latch 72
Latch pivot 72a
Latch tongue 72b
Padlock aperture 72c
Latch receiver 73
Tool holders 80
Back wall 81
Ramp 82
Roller 83
Alternative embodiment cart 2

Preferred embodiment cart 1 is preferably made of stainless steel. This makes it particularly useful in hospital and other sterile environments. Other materials, e.g. aluminum, plastic, steel, powder coated steel or aluminum, and the like can be used. Wheeled platform 10 provides a sturdy base on which items can be loaded and/or mounted. Four caster wheels 11 provide support for platform 10. Preferably, the casters comprise double bearing quite casters, and at least two are fixed with brakes. Platform 10 is sufficiently large to support a large wheeled commercial floor cleaning machine and multiple additional tools and supplies. Thus, it is preferably about 3 feet by 6 feet, as this provides substantial surface area for loading and mounting large commercial cleaning machines and supporting equipment. Yet even at 3 feet by 6 feet, platform 10 and accordingly cart 1 will fit on most elevators and through most hallways.

Frame members 20, 30, 40 and 50 serve to enclose the space on platform 10 and help keep items placed thereon from falling off. They also provide supports for mounting tool holders 80 at various points on cart 1. The frames are preferably bent tubular members. Stainless steel is used in the preferred embodiment but other types of metal tube can be used as well. End frame member 20 is an inverted U-shaped tubular member having corner posts 20a mounted on platform 10, and a cross bar 20b extending between the tops of corner posts 20a. A tool holder band 21 is secured at its ends to the corner posts 20a near the top thereof. A plurality of tool holders 80 are mounted on tool holder band 21. An end retaining band 22 is secured between the corner post 20a at the lower portion thereof.

There are two similarly constructed side frame members 30 which include a vertical post 30a secured to platform 10 and a cross bar 30b bent from and projecting rearwardly from the top of corner post 30a and secured to the corner post 20a of an end frame member 20. Vertical posts 30a define one end of a ramp opening on each side of platform 10.

A mid-frame 40 of inverted “U” configuration like end frame 20 is mounted across the width of and between the ends of platform 10, a bit closer to the end opposite end frame 20, to provide the ramp opening between its vertical posts 40a and the vertical posts 30a of side frame members 30. It is in each of these side openings that the hinged ramps 70 are positioned. Vertical posts 40a extend upwardly from platform 10 and are joined at their tops by a crossbar 40b, all of which are formed in a bending operation. A tool holder band 41 is mounted between vertical posts 40a, near the top thereof, generally opposite the tool holder band 21 on end frame 20. Like band 21, tool holder band 41 includes a plurality of tool mounting members 80.

Mid-frame 40 also includes a lower mid-frame 45 having a vertical leg 45a mounted inwardly from the side edges of platform 10, and including a cross bar 45b which extends from vertical post 45a back to its juncture with one of the vertical post 40a of mid-frame 40.

End frame assembly 50 comprises two corner frame members 51, an end lower frame member 52 and a pivoting handle 53. Corner frame members 51 include corner posts 51a and rearwardly extending top bars 51b which extend rearwardly to and joined to the vertical posts 40a of mid-frame 40. End lower frame member 52 is formed similarly to lower mid-frame member 45, and extends upwardly as a vertical post 52a from its mount with platform 10, and is bent into an outwardly extending top cross bar 52b which terminates at and is joined to its adjacent corner post 51a.

A pivoting handle 53 is pivotally mounted at pivot 53a on each side to the rearwardly extending top bar 51b. Handle 53 preferably extends about 6-12 inches passed the end of platform 10, such that cart 1 can be conveniently pushed by a user without bumping his feet or shins against the back edge of cart 1 as he walks across the floor with it. Handle 53 can be pivoted upwardly so that it is out of the way for storage of the cart. A chain 53b holds handle 53 in a desired upper position.

Cabinet 60 is a lockable cabinet, having a door 61 which preferably opens to the rear end of the cart, that is the end at which handle 53 projects from. Cabinet 60 is preferably about a five-cubic foot cabinet. Pivoting handle 53 up and out of the way facilitates opening the rearwardly opening door 61. A top tray 62 on the top of cabinet 60 allows one to locate items on the top of the cabinet without easily falling off the edges. A lock box may also be mounted in said top tray 62. Yet a third tool mounting band 63 is secured to the side of cabinet 60 which faces inwardly with respect to platform 10.

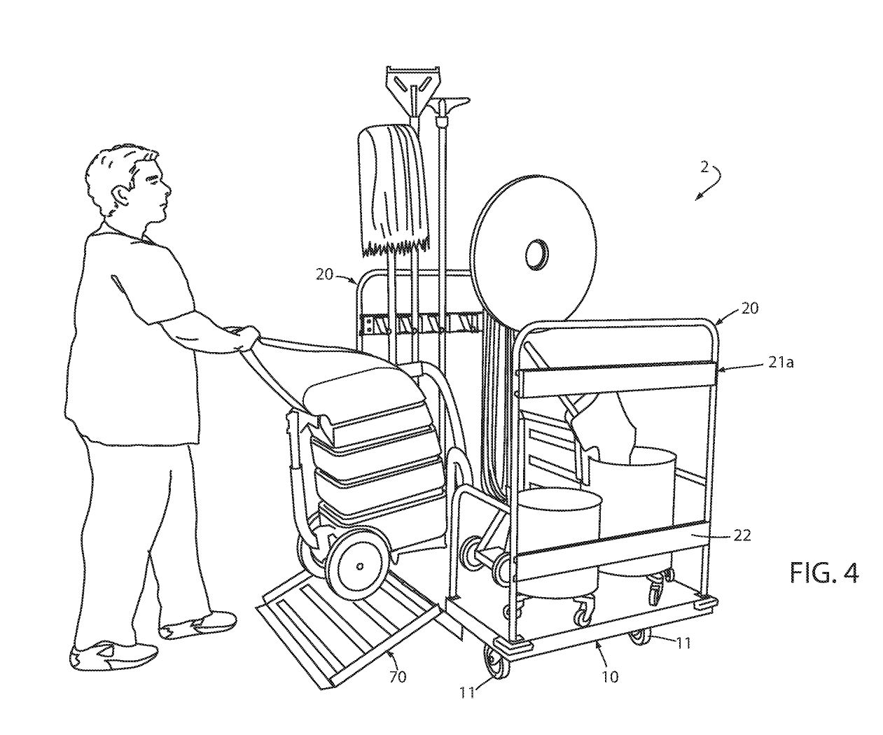

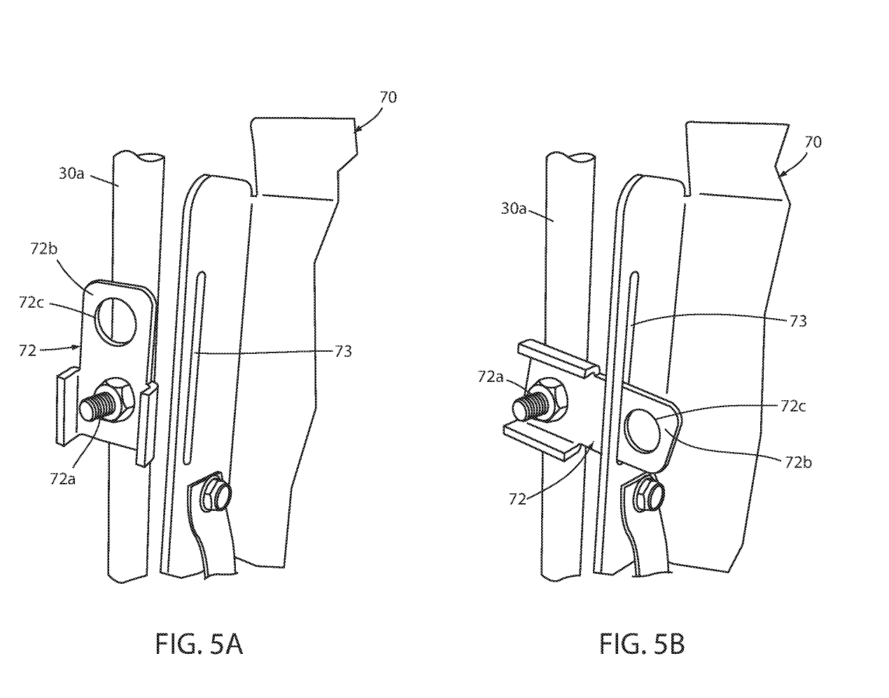

The fold down ramps 70 are mounted on platform 10 by hinges 71. Each ramp 70 can be secured in its upper position by a latch 72 (FIGS. 5A, 5B). Latch 72 is pivotally mounted at 72a to the vertical post 30a of side frame 30. It includes an extending tongue 72b, which can be pivoted upwardly and out of the way of a ramp 70 as shown in FIG. 5A. This allows ramp 70 to be rotated downwardly for engaging the floor and allowing a user to roll a large wheeled appliance up onto cart 1, as shown in FIG. 4. Each ramp 70 preferably includes a nonslip grip surface, and foot pads 70a which cushion the ramp and cause it to settle more quietly onto the floor surface. When ramp 70 is pivoted into its upper position, it is locked in place by rotating latch 72 downwardly such that tongue 72b extends into a slot 73 located in the end of ramp 70 (FIG. 5B). Padlock aperture 72c allows a user to padlock ramp 70 in its up position. With ramps 70 locked in their upward positions, items located on platform 10 are prevented from falling off. The ramps 70 and the corresponding ramp opening is about 3 feet long. The width of the ramp is sufficient to provide a gradual slope up to the platform, and will vary with the height of platform 10 above the floor. 2 to 3 feet would be typical.

Each of the tool holder bands 21, 41 and 63 include a plurality of tool holders 80 mounted thereon. Preferably, about 14 tool holders safely secure mop handles, dust mops, brooms and more. Each tool holder 80 comprises a backwall 81, a ramp wall 82 and a roller 83 which rolls in ramp 82. When a tool handle is placed in holder 80 as shown for example in FIG. 6, the roller 83 tends to roll down and hold the tool handle tightly against backwall 81. These holders are the subject of Applicant's U.S. Pat. No. 4,852,747 entitled Multiple Tool Holder Assembly.

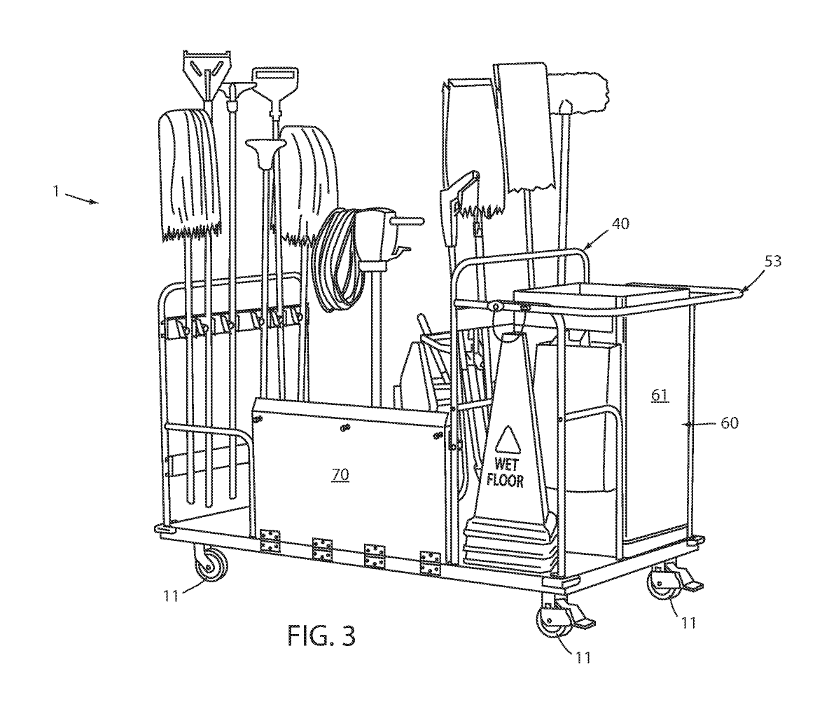

FIG. 3 shows cart 1 loaded for use by floor tech crews for cleaning, stripping and rewaxing tile floors. Thus, it is loaded with a floor stripper machine, blower, ab extractor to extract fluids put on floor, wax applicator, one or two buckets, and various mops, brushes, scrapers, brooms and the like. “WET FLOOR” cones are also carried on the cart. The floor tech crew can proceed to their work area fully loaded, without having to make multiple trips from the supply area to the designated work area.

FIG. 4 not only shows mounting a wheeled floor cleaner on cart 10 by using a ramp 70, but also shows an alternative embodiment cart 2, which does not include a cabinet 60. In alternative embodiment cart 2, the end frames at both ends of the cart are identical and have the construction of end frames 20 as previously described, including their respective tool holder bands 21 and lower bands 22.

Of course, it is understood that the foregoing are preferred embodiments of the invention, and that various changes and alterations can be made within the scope of the invention as claimed and interpreted in accordance with the Doctrine of Equivalents.

1. A utility cart comprising: an elongated wheeled platform having two ends and two sides: said cart having at least one multiple tool holder mounted on said platform; and at least one fold down ramp for wheeling wheeled appliances up onto the platform.

2. The utility cart of claim 1 in which said wheeled platform has a width at said ends and between said sides appropriate for moving said cart through typical hallways, and a length along said sides to enhance surface area, but sufficiently short that said cart can be carried on typical elevators.

3. The utility cart of claim 2 in which said platform is sufficiently large to support a large wheeled commercial floor cleaning machine and multiple additional tools and supplies.

4. The utility cart of claim 1 in which said wheeled platform is about three feet by six feet in dimensions.

5. The utility cart of claim 3 which includes two of said fold down ramps, one on each side of said platform.

6. The utility cart of claim 5 which includes a latch on each side for latching said fold down ramps in their folded-up orientation.

7. The utility cart of claim 1 which also includes a pivotally mounted handle cabinet mounted on said wheeled platform, which folds down and extends beyond one of said ends of said wheeled platform for pushing or pulling said cart, but folds up to minimize floor space necessary for storing said cart.

8. The utility cart of claim 1 which includes a latch for latching said fold down ramp in its folded-up orientation.

9. A utility cart comprising: an elongated wheeled platform having two ends and two sides: said cart having at least one multiple tool holder mounted on said platform; at least one fold down ramp for wheeling wheeled appliances up onto the platform, and at least one cabinet mounted on said wheeled platform.

10. The utility cart of claim 9 in which said cabinet includes a door opening outwardly at one of said ends of said cart.

11. The utility cart of claim 10 which includes two of said fold down ramps, one on each side of said platform.

12. The utility cart of claim 11 which includes a latch on each side for latching said fold down ramps in their folded-up orientation.

13. The utility cart of claim 11 which also includes a pivotally mounted handle, which folds down and extends beyond said end of said wheeled platform at which said cabinet door opens, for pushing or pulling said cart, but folds up to minimize floor space necessary for storing said cart, and out of the way of opening said door of said cabinet.

14. A utility cart comprising: an elongated wheeled platform having first and second ends and first and second sides: said cart having first and second tubular end frame members, one at each said first and second ends of said platform, at least said first end frame at said first end of said cart having a tool holder mounting band mounted on said first end frame, said tool holder mounting band having a plurality of tool holders for holding tools on said cart; said cart having tubular frame members along each side of said cart, said tubular frame member on at least one side of said cart including a ramp opening; at least one fold down ramp for wheeling wheeled appliances up onto the platform located in said ramp opening.

15. The utility cart of claim 14 which includes two of said fold down ramps, one on each side of said platform.

16. The utility cart of claim 15 which includes a latch on each side for latching said fold down ramps in their folded-up orientation.

17. The utility cabinet of claim 14 which includes at least one cabinet mounted on said wheeled platform in a corner thereof and at said second end thereof, said cabinet including a door opening outwardly at said second end of said cart.

18. The utility cart of claim 17 which also includes a pivotally mounted handle, which folds down and extends beyond said second end of said wheeled platform, for pushing or pulling said cart, but which folds up to minimize floor space necessary for storing said cart, and out of the way of opening said door of said cabinet.

19. The utility cart of claim 17 which also includes a mid-frame extending laterally between said sides of said wheeled platform, and located between said cabinet and said first end of said wheeled platform; said mid-frame having a tool holder mounting band mounted on said mid frame, and having a plurality of tool holders thereon.

20. The utility cart of claim 19 which includes a tool holder mounting band mounted on said cabinet, and having a plurality of tool holders thereon.
